(19) United States
(12) Patent Application Publication
(10) Pub. No.: US 2018/0323601 A1
(43) Pub. Date: Nov. 8, 2018

(54) CURRENT CUT-OFF DEVICE, AND WIRE HARNESS

(71) Applicant: Yazaki Corporation, Tokyo (JP)

(72) Inventors: Koki SATO, Makinohara-shi (JP); Koichi UEZONO, Makinohara-shi (JP); Naoya KOJIMA, Makinohara-shi (JP); Hiromichi INOUE, Makinohara-shi (JP)

(73) Assignee: Yazaki Corporation, Tokyo (JP)

(21) Appl. No.: 16/038,477

(22) Filed: Jul. 18, 2018

Related U.S. Application Data
(63) Continuation of application No. PCT/JP2017/003494, filed on Jan. 31, 2017.

(30) Foreign Application Priority Data
Feb. 4, 2016 (JP) 2016-019976

(51) Int. Cl. H02H 3/087; H02H 9/02; H01H 9/10; B60R 16/02

(52) U.S. Cl. CPC H02H 3/087; B60R 16/02; H01H 9/106; H02H 9/02

(57) ABSTRACT

A current cut-off device includes a first current cut-off circuit and a second current cut-off circuit. The first current cut-off circuit is physically cut off in response to a current having a predetermined value or more. The second current cut-off circuit includes at least one semiconductor switching device and is cut off in response to a current having a predetermined value or more. The first current cut-off circuit and the second current cut-off circuit are connected in parallel to each other. A ratio of a current flowing through the first current cut-off circuit to a current flowing through the second current cut-off circuit is set within a prescribed value set in advance, under predetermined conditions.

### CROSS-REFERENCES TO RELATED APPLICATIONS

This application is a continuation of PCT application No. PCT/JP2017/003494, which was filed on Jan. 31, 2017 based on Japanese Patent Application (No. 2016-019976) filed on Feb. 4, 2016, the contents of which are incorporated herein by reference.

### BACKGROUND

### Technical Field

The present invention relates to a current cut-off device and a wire harness available for cutting off an abnormal current in a power supply circuit of a vehicle and the like.

### Description of Related Art

In general, an alternator (a generator) or a battery is installed in a vehicle as a power source, and power supplied from the power source is to be supplied to various electric components (loads) via a wire harness. In such a power supply circuit, when failure or short-circuit occurs, it is probable that a large current will abnormally flow toward the loads from the power source. Furthermore, if the large current abnormally continues to flow, probability of emitting smoke or fire caused by, for example, abnormal heating of the wire harness is also considered. Therefore, for example, a fuse to be melted when the large current flows is generally inserted in the middle of the power supply circuit.

Furthermore, there are cases where, in a main power supply circuit of a vehicle, a part called a fusible link is inserted into a part of the wire harness to prevent overheating of the wire harness. When a large current flows and abnormal heating occurs, the fusible link is melted before breakage occurs at other points of the wire harness, so that it is possible to minimize the occurrence of problems. That is, when the fusible link is adapted, it is possible to prevent the wire harness from being abnormally heated at points other than a specific point or being broken, so that failure maintenance becomes easy.

As conventional arts for protection for an excessive current in a power source, Patent Literatures 1 to 6 are known. An input protection circuit of a USB connection apparatus disclosed in Patent Literature 1 is provided with a serial circuit of a resistor and a fuse, and a semiconductor switch is connected to the serial circuit in a parallel manner. The aim of the input protection circuit is to have a function of controlling a rush current and performing overcurrent protection, and reducing a voltage drop.

In a current limiter disclosed in Patent Literature 2, a main circuit includes a semiconductor switch, a first fuse is connected to a point branched from the main circuit, and the semiconductor switch and the first fuse are connected to each other in a parallel manner. Furthermore, after the semiconductor switch is turned off, the first fuse is melted. A circuit of a second fuse and a resistor is connected to the first fuse in a parallel manner. The second fuse is melted after the first fuse is melted.

In an inverter device disclosed in Patent Literature 3, a serial circuit of a resistor and a fuse, and a switch of an electromagnetic contactor which is connected to the serial circuit in a parallel manner, are provided to a power supply line. At the time of failure, the switch is opened such that the fuse is melted.

In a vehicle power supply disclosed in Patent Literature 4, a bypass circuit capable of turning on and off is serially connected to a fuse. The current capacity of the bypass circuit is set to be small compared to that of the fuse.

In a vehicular power source cut-off device disclosed in Patent Literature 5, a semiconductor switch is serially connected to a fuse. When fault occurs, the fuse is reliably melted by controlling the semiconductor switch.

In a DC breaker disclosed in Patent Literature 6, in a power supply part of a DC power supply, a semiconductor switch is connected to a positive-electrode-side line and a fuse is connected to a negative-electrode-side line.

### PRIOR ART DOCUMENTS

### Patent Literature

[Patent Literature 1]: JP-A-2011-101512

[Patent Literature 2]: JP-A-2013-27308

[Patent Literature 3]: JP-A-2013-192392

[Patent Literature 4]: JP-A-2014-15133

[Patent Literature 5]: JP-A-2014-177208

[Patent Literature 6]: JP-A-2015-11933

In the power supply circuit including the fusible link, when an excessive current flows, it is necessary to reliably melt the fusible link in order to prevent the occurrence of fire by preventing abnormal heating of the wire harness. However, when the fusible link is melted, since it is not possible to restore vehicle's functions as long as parts are not exchanged, it is necessary to avoid a situation in which the fusible link is frequently melted.

Therefore, for example, in an example illustrated in FIG. 3, in a state in which a fusible link FL is connected between an alternator ALT and a load/a battery, when it is assumed that a rated maximum current of the alternator is 150 [A], specifications of a cut-off current of the fusible link are decided such that the fusible link is melted when a current of 300 [A] corresponding to twice of 150 [A] flows, so that fire is reliably prevented from occurring in a wire harness.

In the example illustrated in FIG. 3, it is necessary to decide a sectional area of a conductor of each of an upstream-side electric wire 101, which connects an upstream side of the fusible link to the alternator, and a downstream-side electric wire 102, which connects a downstream side of the fusible link to the load, according to the current specifications of the fusible link in order to avoid melting of the wire harness at points other than the fusible link. If the points other than the fusible link are broken, since the entire wire harness should be exchanged, large effort and cost for maintenance are required.

Specifically, when the specifications of the cut-off current of the fusible link are 300 [A], the sectional area of the conductor of each of the upstream-side electric wire 101 and the downstream-side electric wire 102 need to be 60 [mm²]. That is, a very thick and heavy electric wire should be employed as the upstream-side electric wire 101 and the downstream-side electric wire 102. Consequently, since workability when the wire harness is disposed in a vehicle is deteriorated, fuel efficiency of the vehicle may be reduced.

On the other hand, it is also considered to use the semiconductor switch or the electromagnetic contactor as disclosed in Patent Literatures 1 to 6 instead of the mechanical fusible link of the related art. In the case of using such semiconductor switch and the like, a circuit is cut off for an excessive current and then the circuit can be simply restored to the original state. Consequently, it is not necessary to allow a current to be cut off to have a large margin.

For example, in the circuit configuration illustrated in FIG. 3, in the case of using the semiconductor switch instead of the fusible link, a rated current, by which the semiconductor switch is cut off, can be set to 150 [A] according to the rated maximum current (150 [A]) of the alternator ALT. In such a case, the sectional area of the conductor of each of the upstream-side electric wire 101 and the downstream-side electric wire 102 are decided according to the rated current (150 [A]) of the semiconductor switch. Specifically, it is possible to use the upstream-side electric wire 101 and the downstream-side electric wire 102 in which the sectional area of the conductor is 30 [mm²]. That is, when it is compared with the case of using the mechanical fusible link as illustrated in FIG. 3, since the sectional areas of the upstream-side electric wire 101 and the downstream-side electric wire 102 can be reduced to a half, reduction of a diameter and a weight of the wire harness is expected.

However, it is proven that new problems would occur when designing a power supply circuit actually using the semiconductor switch instead of the mechanical fusible link. Specifically, since a plurality of semiconductor switches should be connected such that conduction and interruption of a large current can be permitted, there is a problem that an external size of an entire device increases by about five times as compared with the case employing the mechanical fusible link.

### SUMMARY

This disclosure relates a current cut-off device and a wire harness, by which it is possible to prevent an increase in an external size together with reduction of a diameter and a weight of the wire harness.

In accordance with one or more embodiments, a current cut-off device and a wire harness have aspects (1) to (5) as follows.

(1) A current cut-off device including:

a first current cut-off circuit that is physically cut off in response to a current having a predetermined value or more; and

a second current cut-off circuit that includes at least one semiconductor switching device and is cut off in response to a current having a predetermined value or more,

in which the first current cut-off circuit and the second current cut-off circuit are connected in parallel to each other, and

in which a ratio of a current flowing through the first current cut-off circuit to a current flowing through the second current cut-off circuit is set within a prescribed value set in advance, under predetermined conditions.

(2) The current cut-off device according to (1), in which the first current cut-off circuit is a fusible link used for a wire harness installed on a vehicle.
(3) The current cut-off device according to (1) or (2), in which an electric resistance value of the second current cut-off circuit is set based on an electric resistance value of the first current cut-off circuit and the ratio.
(4) The current cut-off device according to (3), in which the second current cut-off circuit is configured by a parallel switch circuit in which a plurality of sets of semiconductor switching devices are connected in parallel to each other.
(5) A wire harness including:

the current cut-off device according to any one of claims 1 to 4;

a first electric wire that connects a generator installed in a vehicle and the current cut-off device to each other, and

a second electric wire that connects the current cut-off device and a load or a battery installed in the vehicle to each other,

a sectional area of a conductor of the first electric wire and a sectional area of a conductor of the second electric wire are set according to a rated cut-off current of the first current cut-off circuit.

According to the current cut-off device having the aforementioned configuration (1), since the first current cut-off circuit and the second current cut-off circuit form a parallel circuit, a current flowing in from a power supply side is split into a path of the first current cut-off circuit and a path of the second current cut-off circuit, is merged, and then flows to a load side. Consequently, for example, when a current flowing through the path of the first current cut-off circuit is 50% and a current flowing through the path of the second current cut-off circuit is also 50%, a maximum value (a rated value of a cut-off current) of the current of the first current cut-off circuit and a maximum value (a rated value of a cut-off current) of the current of the second current cut-off circuit become a half, respectively. In this case, an external size of the entire current cut-off device becomes large as compared with a case of only the first current cut-off circuit, but becomes sufficiently small as compared with a case of only the second current cut-off circuit. Furthermore, since the sectional area of a conductor of an electric wire connected to an upstream side of the current cut-off device and the sectional area of a conductor of an electric wire connected to a downstream side thereof are decided by the maximum value (the rated value of the cut-off current) of the current of the first current cut-off circuit, it is possible to reduce the sectional areas to about a half as compared with the case of only the first current cut-off circuit. When the external size and the sectional areas of the conductors of the electric wires are comprehensively evaluated, considerable superiority is confirmed as compared with a case of forming the current cut-off device by using only any one of the first current cut-off circuit and the second current cut-off circuit.

According to the current cut-off device having the aforementioned configuration (2), since the fusible link is used, when the circuit is melted caused by an overcurrent, it is easy to specify a point, at which the circuit was melted, and a point, at which exchange of parts is required, on the wire harness. Furthermore, it is possible to prevent abnormal heating from occurring in points other than the fusible link.

According to the current cut-off device having the aforementioned configuration (3), a ratio of the current flowing through the first current cut-off circuit to the current flowing through the second current cut-off circuit from the splitting part can be decided to a prescribed value set in advance. Consequently, it is possible to appropriately decide the rated value of the cut-off current in the first current cut-off circuit and the rated value of the cut-off current in the second current cut-off circuit. Moreover, based on the rated value of the cut-off current in the first current cut-off circuit, it is possible to appropriately decide the sectional areas of the conductors of the electric wires of the upstream side and the downstream side of the current cut-off device.

According to the current cut-off device having the aforementioned configuration (4), a plurality of sets of semiconductor switching devices are connected to each other in a parallel manner, so that it is possible to adjust an electric resistance value for the current passing through the second current cut-off circuit. Consequently, it is possible to adjust a ratio of currents split into respective paths and flowing of an entire current passing through the current cut-off device.

According to the current cut-off device having the aforementioned configuration (5), it is possible to prevent abnormal heating from occurring in the first electric wire and the second electric wire at points other than the fusible link or to prevent the first electric wire and the second electric wire from being melted.

According to the current cut-off device and the wire harness of one or more embodiments, it is possible to prevent an increase in an external size of the current cut-off device together with reduction of a diameter and a weight of the wire harness. That is, since a parallel circuit is formed of the first current cut-off circuit and the second current cut-off circuit, maximum values of currents flowing through respective paths are reduced, so that diameters of electric wires connected to an upstream side and a downstream side can be reduced and an increase in an external size for the second current cut-off circuit can be prevented.

So far, the invention has been briefly described. Moreover, a mode (hereinafter, referred to as an “embodiment”) for carrying out the invention to be described below is read through with reference to the accompanying drawings, so that details of the invention will be further clarified.

### BRIEF DESCRIPTION OF THE DRAWINGS

FIG. 1 is an electric circuit diagram illustrating a configuration example of a current cut-off device in an embodiment.

FIG. 2 is a block diagram illustrating a configuration example of a second current cut-off included in a current cut-off device illustrated in FIG. 1.

FIG. 3 is an electric circuit diagram illustrating a configuration example of a general current cut-off device configured using a fusible link.

### DETAILED DESCRIPTION

Hereinafter, a specific embodiment will be described below with reference to the drawings.

First, a configuration of a current cut-off device will be described.

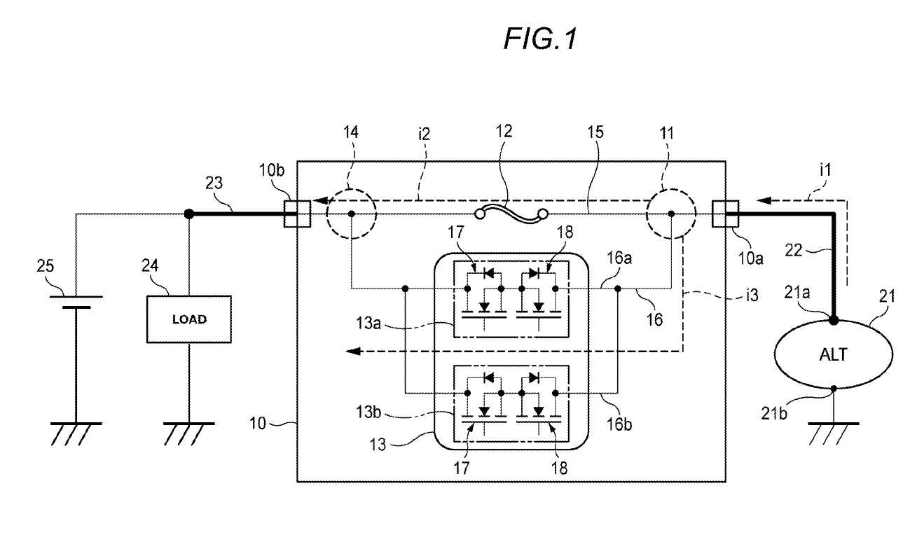

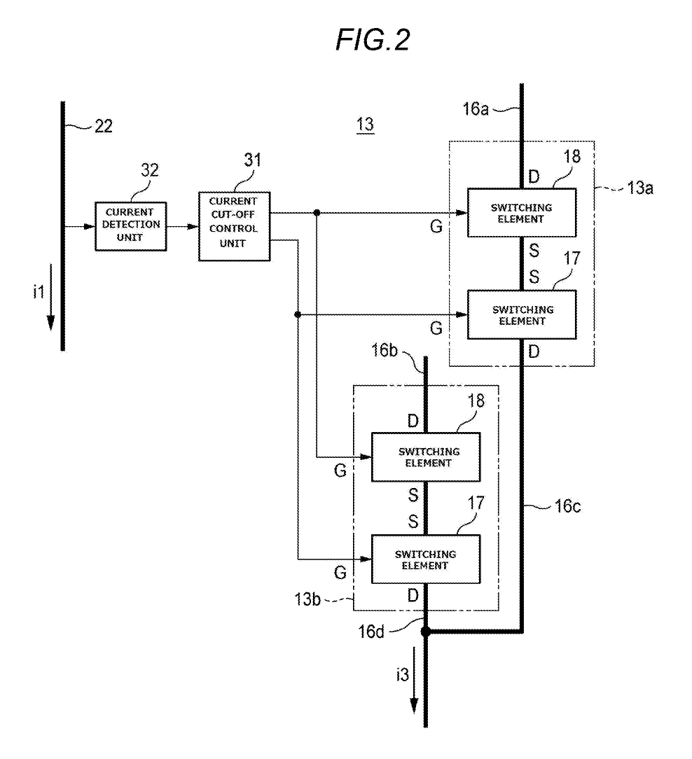

A configuration example of a current cut-off device 10 in an embodiment is illustrated in FIG. 1. Furthermore, a configuration example of a second current cut-off circuit 13 included in the current cut-off device 10 (illustrated in FIG. 1) is illustrated in FIG. 2.

The current cut-off device 10 illustrated in FIG. 1, for example, is installed in a vehicle and is used in a state of being inserted into a part of a wire harness arranged for electrical connections among various electric components on the vehicle. That is, in the example illustrated in FIG. 1, an upstream-side terminal 10a of the current cut-off device 10 is connected to a positive-electrode-side electrode 21a of an alternator (a generator) 21 via an upstream-side electric wire 22, and a downstream-side terminal 10b is connected to a load 24 and a positive-electrode-side electrode of a battery 25 via a downstream-side electric wire 23. The alternator 21, the load 24, and a negative-electrode-side electrode of the battery 25 are connected to the ground.

In the current cut-off device 10, an electrical conduction state is normally present between the terminal 10a and the terminal 10b. However, when an overcurent flows, the current cut-off device 10 cuts off the circuit, and controls no current to flow among the alternator 21, the load 24, and the battery 25. The current cut-off device 10, the upstream-side electric wire 22, and the downstream-side electric wire 23 are formed as a part of a wire harness.

In the configuration illustrated in FIG. 1, the current cut-off device 10 includes a splitting part 11, a first current cut-off circuit 12, a second current cut-off circuit 13, and a merging part 14. A current i1, which flows from the alternator 21 toward the terminal 10a through the upstream-side electric wire 22, is split into two paths of a flow path 15 and a flow path 16 by the splitting part 11. A current i2 of the flow path 15 passes a path passing through the first current cut-off circuit 12, and a current i3 of the flow path 16 passes a path passing through the second current cut-off circuit 13. Furthermore, the current i2 of the flow path 15 and the current i3 of the flow path 16 are merged with each other by the merging part 14 and flow to the side of the load 2 from the terminal 10b.

The first current cut-off circuit 12 is formed of a mechanical fusible link. The fusible link is formed of a conductive material similar to that of a general electric wire, but is formed of a very thin conductor as compared with another electric wire connected to the fusible link before and after the fusible link. Consequently, the first current cut-off circuit 12, similar to the case of a general fuse, is physically cut off when a prescribed large current flows and the fusible link is melted.

At the time of occurrence of abnormality such as short circuit, the fusible link is melted earlier than other points when an overcurrent flows through the wire harness, so that it is possible to prevent emitting smoke or fire caused by abnormal heating of the wire harness. Furthermore, since a point to be heated and a point to be melted are limited only to the fusible link, maintenance and repair of a vehicle become easy.

On the other hand, the second current cut-off circuit 13 is formed of a semiconductor switch. In the example illustrated in FIGS. 1 and 2, two semiconductor switch circuits 13a and 13b are connected in parallel to each other. Each of the semiconductor switch circuits 13a and 13b includes two switching elements 17 and 18 serially connected to each other.

The switching elements 17 and 18 are formed as N channel type power MOSFETs (field effect transistors) and parasitic diodes are serially connected to each other in a state in which their polarities are opposite to each other. For example, as illustrated in FIG. 2, for the semiconductor switch circuit 13a, a drain terminal (D) of the switching element 18 is connected to a flow path 16a, a source terminal (S) of the switching element 17 and a source terminal (S) of the switching element 18 are connected to each other, and a drain terminal (D) of the switching element 17 is connected to a flow path 16c. In this way, even though a voltage having a polarity opposite to a polarity at a normal time is applied, it is possible to prevent an unintended current from flowing or a semiconductor and the like from being destructed.

As illustrated in FIGS. 1 and 2, the reason for connecting the plurality of semiconductor switch circuits 13a and 13b to each other in a parallel manner is for permitting passing of a large current and for adjusting a resistance value for a current passing through this path. In the example illustrated in FIGS. 1 and 2, the two semiconductor switch circuits 13a and 13b are connected in parallel to each other, however, there are cases where three or more semiconductor switch circuits are connected in parallel to one another according to conditions.

As illustrated in FIG. 2, the second current cut-off circuit 13 includes a current cut-off control unit 31 and a current detection unit 32. The current detection unit 32, for example, can detect a current value of a DC current i1 flowing through the upstream-side electric wire 22. The current cut-off control unit 31 outputs a control signal for turning on and off a gate terminal (G) which is control input of the switching elements 17 and 18 of each of the semiconductor switch circuits 13a and 13b.

Specifically, in normal conditions, the drain and the source of each of the switching elements 17 and 18 of the semiconductor switch circuits 13a and 13b is controlled to be in an ON (conductive) state, and when the current detection unit 32 detects an overcurrent equal or more than a predetermined value set in advance, the drain and the source of each of the switching elements 17 and 18 of the semiconductor switch circuits 13a and 13b is controlled to be in an OFF (non-conductive) state.

### <Description of Control in Current Cut-Off Device 10>

In the embodiment of the invention, in the current cut-off device 10 illustrated in FIG. 1, a ratio of the current i2 split by the splitting part 11 and flowing to the flow path 15 side to the current i3 split by the splitting part 11 and flowing to the flow path 16 side is controlled to be a prescribed value set in advance, in at least a normal use state. For example, both a ratio of (i2/i1) and a ratio of (i3/i1) are controlled to be 50%.

Actually, a relation between electric resistance employing the fusible link as a main constituent in the first current cut-off circuit 12 and electric resistance in the second current cut-off circuit 13 is relatively adjusted, so that it is possible to specify the ratio.

For example, when an electric resistance value of a circuit employing the fusible link as a main constituent in the first current cut-off circuit 12 is R12 and an electric resistance value of the second current cut-off circuit 13 is R13, if it is adjusted to satisfy the relation of “R12=R13”, the following states are obtained.

i2=i3

i2/i1=50[%]

i2/i1=50[%]

That is, the current i2 flowing through the fusible link in the first current cut-off circuit 12 can be reduced to a half of the entire current (i1). Furthermore, the current i3 flowing through the second current cut-off circuit 13 can also be reduced to a half of the entire current (i1).

The electric resistance value R12 is decided by a material, a thickness and the like of a conductor constituting the fusible link. The electric resistance value R13 is decided by ON resistance of the switching elements 17 and 18, the number of parallel connections of the semiconductor switch circuits 13a and 13b, and the like. Consequently, it is possible to design the circuits to satisfy the relation of “R12=R13”.

Next, a specific example of specifications and a design procedure will be described.

As a specific example of the specifications of the alternator 21, the case where a rated maximum current is 150 [A] is assumed. It is noted that instantaneous flowing of a large current compared to the rated maximum current is permitted. Consequently, when the current i1 flowing through the upstream-side electric wire 22 from the alternator 21 is equal to or more than the prescribed value 150 [A], it is regarded as an overcurrent and conduction needs to be interrupted.

Based on the prescribed value 150 [A] of the current i1, the current cut-off device 10 is designed. The current i1 is split into the currents i2 and i3 by the splitting part 11 in the current cut-off device 10. As described above, when the condition of “i2/i1=50 [%]” and “i3/i1=50 [%]” is assumed, the prescribed value of the current i2 is 75 [A] corresponding to a half of 150 [A]. The prescribed value of the current i3 is also 75 [A] corresponding to a half of 150 [A].

On the other hand, in the case of using the fusible link, when a circuit is cut off caused by melting, restoration to the original state is not possible as long as parts are not exchanged. Consequently, in order to avoid a situation in which melting frequently occurs and to be able to reliably prevent occurrence of fire from the wire harness, it is necessary to decide the specifications of the fusible link. Specifically, the fusible link is designed to be melted when a current corresponding to twice of the prescribed value flows.

That is, in the case of the current cut-off device 10 illustrated in FIG. 1, since the prescribed value of the current i2 flowing through the fusible link of the first current cut-off circuit 12 is 75 [A], a reference value of a current, by which the fusible link is melted, is decided to 150 [A] corresponding to twice of the prescribed value. That is, it is decided to employ the fusible link having a rated value 150 [A] of a cut-off current.

Next, the second current cut-off circuit 13 is designed to satisfy the condition of “i2/i1=50 [%]” and “i3/i1=50 [%]”. That is, the second current cut-off circuit 13 is designed such that the electric resistance value of the second current cut-off circuit 13, which represents the resistance value of the flow path 16 through which the current i3 flows, is approximately the same as the resistance value of the fusible link of the first current cut-off circuit 12. Specifically, semiconductor devices having appropriate characteristics are selected as the switching elements 17 and 18, or the circuit number of the semiconductor switch circuits 13a and 13b connected in parallel to each other is adjusted.

Next, sectional areas (mm²) of conductors in the upstream-side electric wire 22 and the downstream-side electric wire 23 are decided. When the sectional shape of the conductor is circle shape, an electric wire diameter (a diameter) may be defined instead of the sectional area. When the sectional areas of these electric wires are decided, matching is considered such that the fusible link of the first current cut-off circuit 12 correctly operates. That is, when a large current flows, since melting absolutely occurs in points of the fusible link, it is necessary to design such that melting or abnormal heating does not occur in points of the upstream-side electric wire 22 and the downstream-side electric wire 23.

Actually, for matching with the rated value of the cut-off current of the fusible link, the sectional areas of the upstream-side electric wire 22 and the downstream-side electric wire 23 are decided. In the aforementioned condition, since the rated value of the cut-off current of the fusible link is 150 [A], the sectional area of each of the upstream-side electric wire 22 and the downstream-side electric wire 23 is decided to 30 [mm²] so as to match with the rated value. The numeral value of the sectional area can be easily specified using a calculation formula or a table based on the rated value of the cut-off current.

### <Comparison of Various Types of Current Cut-Off Devices Having Different Configurations>

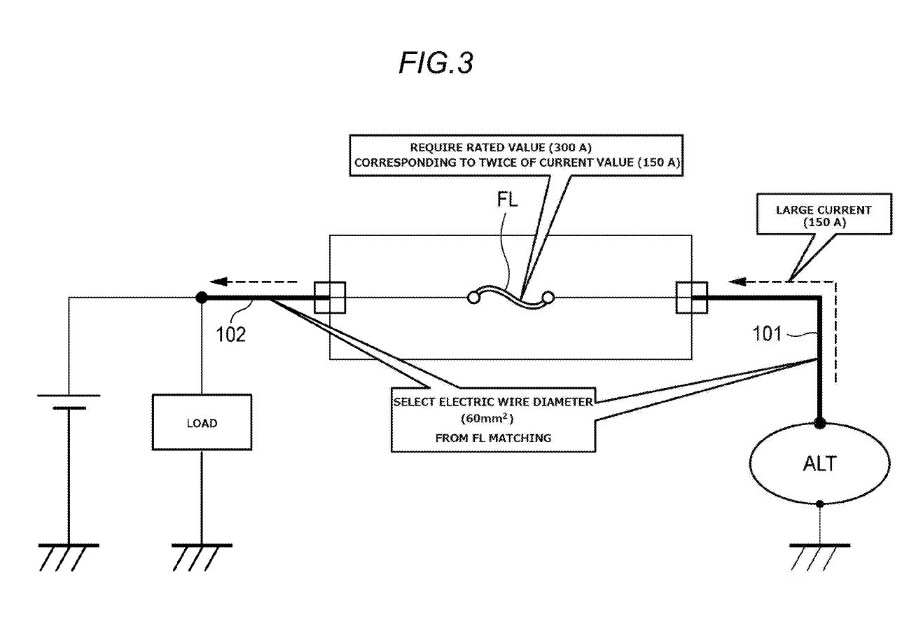

In order to be able to evaluate superiority of the current cut-off device 10 illustrated in FIG. 1, current cut-off devices having three types of configurations (configuration A, configuration B, and configuration C) different from one another are compared with one another. As the current cut-off device having the “configuration A”, a case where a current cut-off device is formed using only a mechanical fusible link as illustrated in FIG. 3 is assumed. As the current cut-off device having the “configuration B”, a case where a current cut-off device is formed of only a semiconductor switch such as the second current cut-off circuit 13 of FIG. 1 and no fusible link is included is assumed. Furthermore, the “configuration C” corresponds to the current cut-off device 10 of the invention illustrated in FIG. 1.

All of the “configuration A”, the “configuration B”, and the “configuration C” are compared with a current cut-off device designed by assuming a case where the rated value of the cut-off current of an entire current cut-off device is 150 [A]. For respective current cut-off devices having the “configuration A”, the “configuration B”, and the “configuration C”, a list of electric wire diameters (sectional areas [mm²]), external sizes, and comprehensive evaluation of the upstream-side electric wire 22 and the downstream-side electric wire 23 is illustrated in the following Table 1. The “external sizes” indicate relative values when a dimension of the “configuration B” is set to 100.

TABLE 1

| | sectional areas | | comprehensive |
|---|---|---|---|
| configuration | [mm²] | external sizes | evaluation |
| configuration A | 60 | GOOD (20) | NOT GOOD |
| configuration B | 30 | NOT GOOD (100) | NOT GOOD |
| configuration C | 30 | GOOD (30) | EXCELLENT |

In the case of the current cut-off device having the “configuration A”, since the rated value of the cut-off current of the fusible link is 300 [A] (corresponding to twice of the rated value of the current i1), the electric wire diameters (the sectional areas) of the upstream-side electric wire 22 and the downstream-side electric wire 23 are 60 as illustrated in the Table 1 above for the purpose of matching with the specifications of the fusible link.

In the case of the current cut-off device having the “configuration B”, since no fusible link is used, the electric wire diameters of the upstream-side electric wire 22 and the downstream-side electric wire 23 are decided according to the rated value (150 [A]) of the current i1 to be cut off by using a semiconductor switch. Consequently, as illustrated in the Table 1 above, the electric wire diameters (the sectional areas) are 30.

In the case of the current cut-off device having the “configuration C”, since the rated value of the cut-off current of the fusible link is 150 [A] (corresponding to twice of the rated value of the current i2), the electric wire diameters (the sectional areas) of the upstream-side electric wire 22 and the downstream-side electric wire 23 are 30 as illustrated in the Table 1 above for the purpose of matching with the specifications of the fusible link. Furthermore, since the cut-off current of the second current cut-off circuit 13 is 75 [A], the electric wire diameters (the sectional areas) may be 30 even in consideration of the entire rated value (150 [A]) of the current i1.

On the other hand, the external size has a minimum value (20) in the case of the “configuration A” using only the fusible link. In the case of the current cut-off device having the “configuration C”, since it is necessary to install the second current cut-off circuit 13 in addition to the fusible link, the external size has a value (30) slightly larger than that of the “configuration A”. On the other hand, in the case of the current cut-off device having the “configuration B”, since a plurality of semiconductor switches should be connected in parallel to each other in order to enable conduction and interruption of a large current (150 [A]), the external size is proven to have a very large value 100 as a result.

Consequently, as illustrated in the Table 1 above, when the electric wire diameters of the upstream-side electric wire 22 and the downstream-side electric wire 23 and the “external sizes” are comprehensively evaluated, considerable superiority is confirmed in the “configuration C”, that is, the current cut-off device 10 of the invention. That is, in the case of the “configuration A”, since the electric wire diameters of the upstream-side electric wire 22 and the downstream-side electric wire 23 are excessively large, large deterioration occurs in terms of wiring workability and weight of the wire harness. In the case of the “configuration B”, since the number of semiconductor switches to be installed increases and a sufficient heat radiating space should be ensured, the current cut-off device increases in size and it is necessary to ensure an extra space in order to wiring the wire harness.

### <Possibility of Deformation>

In the second current cut-off circuit 13 illustrated in FIG. 2, the current detection unit 32 detects the current i1 flowing through the upstream-side electric wire 22, however, the current detection unit 32 may detect currents of other points, for example, the current of the downstream-side electric wire 23 or the current i3 of the flow path 16. Furthermore, in the example of FIG. 2, one the current cut-off control unit 31 controls ON and OFF of the plurality of semiconductor switch circuits 13a and 13b by using a common control signal, however, the current cut-off control unit 31 may individually control the semiconductor switch circuits. Furthermore, when devices such as the switching elements 17 and 18 include a current detection function and an overcurrent cut-off function, it is possible to omit the current cut-off control unit 31 and the current detection unit 32 by using the functions.

According to one or more embodiments, the current cut-off device includes:

a first current cut-off circuit (12) that is physically cut off in response to a current having a predetermined value or more; and

a second current cut-off circuit (13) that includes at least one semiconductor switching device and is cut off in response to a current having a predetermined value or more,

the first current cut-off circuit (12) and the second current cut-off circuit (13) being connected in parallel to each other, and under predetermined conditions, a ratio of a current (i2) flowing through the first current cut-off circuit (12) to of a current (i3) flowing through the second current cut-off circuit (13) being a prescribed value set in advance.

In the current cut-off device, the first current cut-off circuit (12) is a fusible link used for a wire harness installed on a vehicle.

In the current cut-off device, an electric resistance value of the second current cut-off circuit is decided based on an electric resistance value of the first current cut-off circuit and the ratio.

In the current cut-off device, the second current cut-off circuit is constituted by a parallel switch circuit in which a plurality of sets of semiconductor switching devices (semiconductor switch circuits 13a and 13b) are connected in parallel to each other.

According to one or more embodiments, a wire harness includes the current cut-off device;

a first electric wire (an upstream-side electric wire 22) that connects a generator installed in a vehicle and the current cut-off device to each other, and

a second electric wire (a downstream-side electric wire 23) that connects the current cut-off device and a load or a battery installed in the vehicle to each other,

a sectional area of a conductor of the first electric wire and a sectional area of a conductor of the second electric wire being decided according to a rated cut-off current in the first current cut-off circuit.

Although the invention has been described in detail with reference to specific embodiments, it is obvious for those skilled in the art that various modifications and corrections can be made without departing from the spirit and scope of the invention.

According to the current cut-off device and the wire harness of one or more embodiments, it would be possible to prevent an increase in an external size together with reduction of a diameter and a weight of the wire harness. The current cut-off device and the wire harness would cut-off an abnormal current in a power supply circuit of a vehicle and the like.

### REFERENCE SIGNS LIST

10: current cut-off device
10a, 10b: terminal
11: splitting part
12: first current cut-off circuit
13: second current cut-off circuit
13a, 13b: semiconductor switch circuit
14: merging part
15, 16, 16a, 16b: flow path
17, 18: switching element
21: alternator
22: upstream-side electric wire
23: downstream-side electric wire
24: load
25: battery
31: current cut-off control unit
32: current detection unit

What is claimed is:

1. A current cut-off device comprising:
a first current cut-off circuit that is physically cut off in response to a current having a predetermined value or more; and
a second current cut-off circuit that includes at least one semiconductor switching device and is cut off in response to a current having a predetermined value or more,
wherein the first current cut-off circuit and the second current cut-off circuit are connected in parallel to each other, and
wherein a ratio of a current flowing through the first current cut-off circuit to a current flowing through the second current cut-off circuit is set within a prescribed value set in advance, under predetermined conditions.

2. The current cut-off device according to claim 1, wherein the first current cut-off circuit is a fusible link used for a wire harness installed on a vehicle.

3. The current cut-off device according to claim 1, wherein an electric resistance value of the second current cut-off circuit is set based on an electric resistance value of the first current cut-off circuit and the ratio.

4. The current cut-off device according to claim 3, wherein the second current cut-off circuit is configured by a parallel switch circuit in which a plurality of sets of semiconductor switching devices are connected in parallel to each other.

5. A wire harness comprising:
the current cut-off device according to claim 1;
a first electric wire that connects a generator installed in a vehicle and the current cut-off device to each other, and
a second electric wire that connects the current cut-off device and a load or a battery installed in the vehicle to each other,
a sectional area of a conductor of the first electric wire and a sectional area of a conductor of the second electric wire are set according to a rated cut-off current of the first current cut-off circuit.
